(19) United States
(12) Patent Application Publication
(10) Pub. No.: US 2010/0091099 A1
(43) Pub. Date: Apr. 15, 2010

(54) SINGULARIZER DEVICE FOR A MAIL-SORTING SYSTEM

(75) Inventor: Cristiano Franzone, Genova (IT)

Correspondence Address: FSP LLC, P.O. BOX 890, VANCOUVER, WA, 98666, US

(73) Assignee: ELSAG DATAMAT SPA, Genova (IT)

(21) Appl. No.: 12/562,123

(22) Filed: Sep. 17, 2009

(30) Foreign Application Priority Data
Sep. 18, 2008 (EP) 08425610.6

(51) Int. Cl. H04N 7/18; B07C 5/00; B07C 5/08; B07C 5/34; G06K 9/00

(52) U.S. Cl. 348/61; 209/552; 382/101; 348/E07.085

(57) ABSTRACT

A singularizer device for a mail-sorting system configured for receiving at input homogeneous lots of postal objects and feeding at output postal objects that have been singularized, i.e., physically separated from one another, to the mail-sorting system; each lot of homogeneous postal objects comprises postal objects having common dimensional parameters and/or physical/constructional parameters. The singularizer device is provided with sensor means designed to detect the type of lot fed at input for implementing automatically a respective singularization program suited to the type of postal objects detected.

The present invention relates to a singularizer device for a mail-sorting system.

### BACKGROUND OF THE INVENTION

Current mail-sorting systems handle flows of postal objects of various types (for example, letters, postcards, flats—i.e., cumbersome postal objects, open magazines, postal objects wrapped in plastic material, etc.) using singularizer devices of various types suitable for executing specific sorting programs for treating objects having specific physical and/or dimensional characteristics.

### SUMMARY OF THE INVENTION

The aim of the present invention is to provide a singularizer device for a system for sorting postal objects which will be able to recognize the type of postal objects fed at input and to modify its own operation accordingly.

The above aim is achieved by the present invention in so far as it relates to a singularizer device for a mail-sorting system configured for receiving at input homogeneous lots of postal objects and supplying at output postal objects that are singularized, i.e., physically separated from one another, to said mail-sorting system, each lot of homogeneous postal objects comprising postal objects having common dimensional parameters and/or physical/constructional parameters, said singularizer device being characterized in that it is provided with sensor means designed to detect the type of lot fed at input for implementing automatically a respective singularization program suited to the type of postal objects detected.

### BRIEF DESCRIPTION OF THE DRAWINGS

The invention will now be illustrated with particular reference to the attached figures, which represents a preferred non-limiting embodiment thereof and in which:

FIG. 1 illustrates schematically, by means of a simplified block diagram, a system for sorting postal objects, implemented according to the teachings of the present invention;

FIG. 2 illustrates at a schematic level, in front view and with parts removed, the mechanical structure of the system of FIG. 1;

FIG. 3 illustrates, in perspective view and at an enlarged scale, a detail of the system of FIG. 2;

FIGS. 4, 4b illustrate, in top plan view, an output of the system of FIG. 1 according to two different embodiments;

FIGS. 5 and 6 illustrate, in perspective view and in different operative positions, a further output of the system of FIG. 1;

FIG. 7 illustrates, in front view, the channel of FIGS. 4 and 4b; and

FIGS. 8, 9, 10 and 11 illustrate details of the system according to the invention.

### DETAILED DESCRIPTION OF THE INVENTION

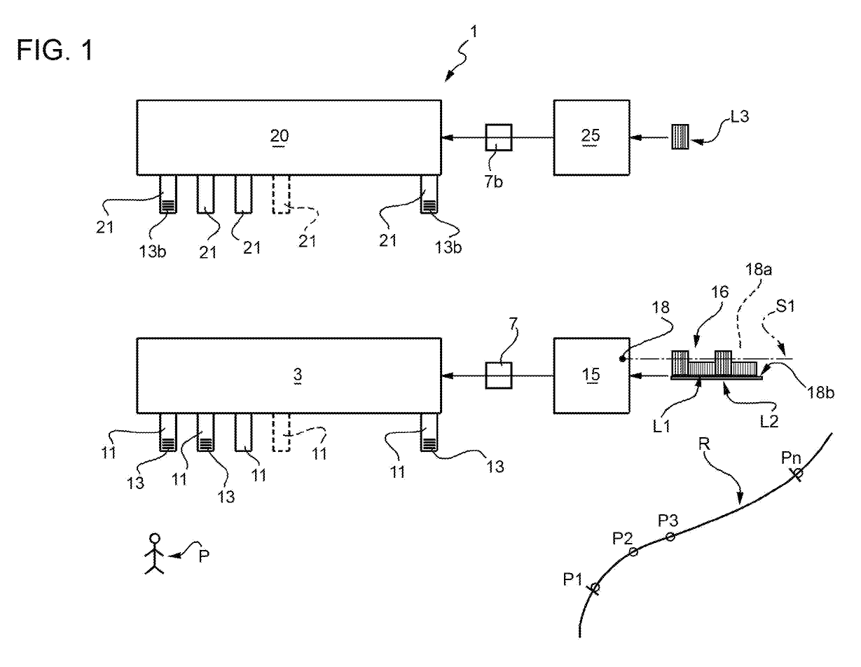

In FIG. 1 designated as a whole by 1 is a system for sorting postal objects, which uses a singularizer device built according to the teachings of the present invention.

The system 1 comprises a mail-sorting device 3, which receives a flow of postal objects 7 at input and has a plurality of outputs 11, fed on which are groups 13 of postal objects 7 that have been sorted.

The postal objects 7, of a plane rectangular type, are: of standard dimensions, i.e., ones having dimensions comprised within the following ranges: length: 120-292 mm; height 85-180 mm; thickness: up to 6 mm; and weight: up to 100 g; and/or of extended formats, i.e., ones including envelopes up to the known C4 format, characterized by a length of 330 mm and a height of 235 mm, and up to 10 mm in thickness and 300 g in weight, and moreover including objects of similar formats but wrapped in cellophane—e.g. polywrapped—or open magazines. As is known, each group of sorted postal objects, if they are also sequenced, comprises a plurality of stacked postal objects, which are ordered according to successive delivery points (P0, P1, P2, . . . Pn—FIG. 1) set along a delivery path R along which a postman (not illustrated) moves for sequential delivery of the postal objects at the delivery points P0, P1, P2, . . . Pn reached in successive instants.

The creation of the groups 13 of sequenced postal objects 7 is obtained using techniques of a known type that are not further specified or described in detail; for this reason, the sorting device 3 is illustrated schematically.

The device for sorting and sequencing mail 3 is coupled to a singularizer device 15, which receives a plurality of homogeneous lots 16 of postal objects 7 at input and supplies at output the postal objects 7 that have been singularized (i.e., physically separated from one another) to the mail-sorting device 3. Each lot of homogeneous postal objects comprises postal objects having common dimensional parameters and/or physical/constructional parameters. A lot may be formed also by one single postal object.

For example, the homogeneous lots may be formed by objects having dimensional parameters smaller than a threshold value. In this way there may be defined a first type of homogeneous lot L1 formed by postal objects having a maximum height (measured with respect to a horizontal resting surface on which the postal objects lie) of less than a threshold value S1, whilst the other postal objects (extended postal objects) are grouped together in such a way as to form a second type of homogeneous lot L2, in which the postal objects have a maximum height (once again measured with respect to the resting surface) of more than the threshold value S1.

The singularizer device 15 is designed to recognize automatically the type of lot fed at input for setting automatically (i.e., without intervention on the part of the operator) a singularization program characterized by respective singularization parameters suited to the type of lot handled.

For example, to distinguish between the types of lots L1 and L2 devices of an optical type 18 can be used, which operate according to known technologies (e.g., diffuse sensors) for detecting overstepping of the threshold S1.

The optical device 18 can define an optical path 18a (FIG. 1) that extends parallel to a resting surface 18b along which the postal objects are pushed. The distance between the resting surface 18b and the optical path 18a represents precisely the threshold S1. When the postal objects of the lot (L1)—for a certain position (minimum distance) with respect to a reference—do not intercept the optical path 18b, the presence of a lot of type L1 is detected and a first singularization program is activated. When the postal objects of the lot (L2) intercept—for a certain position (minimum distance) with respect to a reference—the optical path 18b, the presence of a lot of type L2 is detected and a second singularization program is activated.

The first singularization program implements, for example, the following parameters of the singularizer device 15:
conveying rate: 3.8 m/s;
singularization gap: 20 ms; and
acceleration ramp: 15 ms.
   and, for example, the following settings:
rate of advance of magazine belt: 10 cm/s;
level of vacuum in the suction chamber of the extraction belt: 200 mbar;
distance of the anti-double assembly from the extraction belt: 0.2 mm; and
braking force of the anti-double assembly orthogonal to the letter being extracted equal to a first value (for example, 5 N); said braking force is exerted (according to known techniques) by a rubberized-buffer assembly (not illustrated) mounted on elastic devices, the deformation of which enables forces of variable intensity to be exerted on the postal objects that are singularized; in this case, a high force (5 N, precisely) is exerted, which results in a considerable braking action.

The second singularization program implements, for example, the following parameters of the singularizer device:
conveying rate: 3.0 m/s;
singularization gap: 40 ms; and
acceleration ramp: 40 ms.
   and, for example, the following settings:
rate of advance of the magazine belt: 5 cm/s;
level of vacuum in the suction chamber of the extraction belt: 100 mbar;
distance of the anti-double assembly from the extraction belt: 3 mm; and
braking force of the anti-double assembly orthogonal to the letter being extracted equal to a second value (for example, 3 N); said braking force, exerted precisely by a rubberized-buffer assembly, assumes a lower value (3 N, precisely), which results in a reduced braking action.

In addition, the singularizer device 15 is designed to recognize other types of lots of postal objects defined by physical characteristics such as:
the presence of a plasticated wrapper that encloses the postal object;
the presence of open magazines formed by a plurality of folded sheets grouped together.

The detection of a plasticated wrapper occurs through sensors and/or devices of a known type, designed to detect the presence of plastic film wrapped round the postal object being sorted.

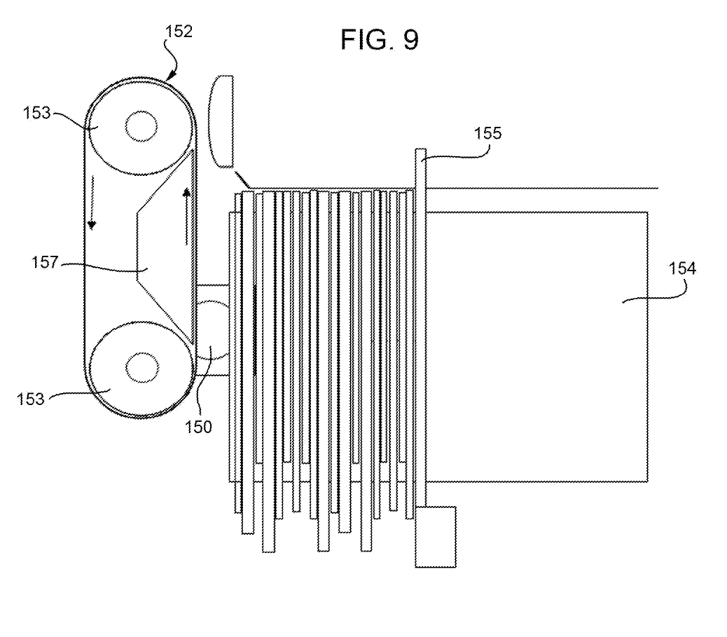

For example, a video camera 150 can be used (FIG. 9) set in the proximity of a motor-driven singularization belt 152 of the singularizer device 15 that moves between a pair of pulleys 153 with vertical axis. The singularization belt 152 (provided with holes and coupled to a suction device 157) is designed to pick up postal objects one by one from a pack of postal objects (forming a lot) that moves on a resting surface 154 under the thrust of a motor-driven paddle 155. The video camera 150 is set alongside the extraction belt at the side of the pulley 153 set in front of the pack of mail to be extracted. The signal of the video camera 150 that hence represents a portion of the plane surface of the postal object facing the extraction belt 152 is then processed by means of known algorithms for detection of high-reflectance areas indicating the presence of a plasticated wrapper.

Detection of open magazines can occur, in the case where the postal objects are of the open-magazine type with square spine, i.e., open magazines characterized by a shape of the bottom spine with C-shaped cross section, with the following modalities. An image-acquisition and processing device (vision system) detects the shapes of the underside of the postal objects.

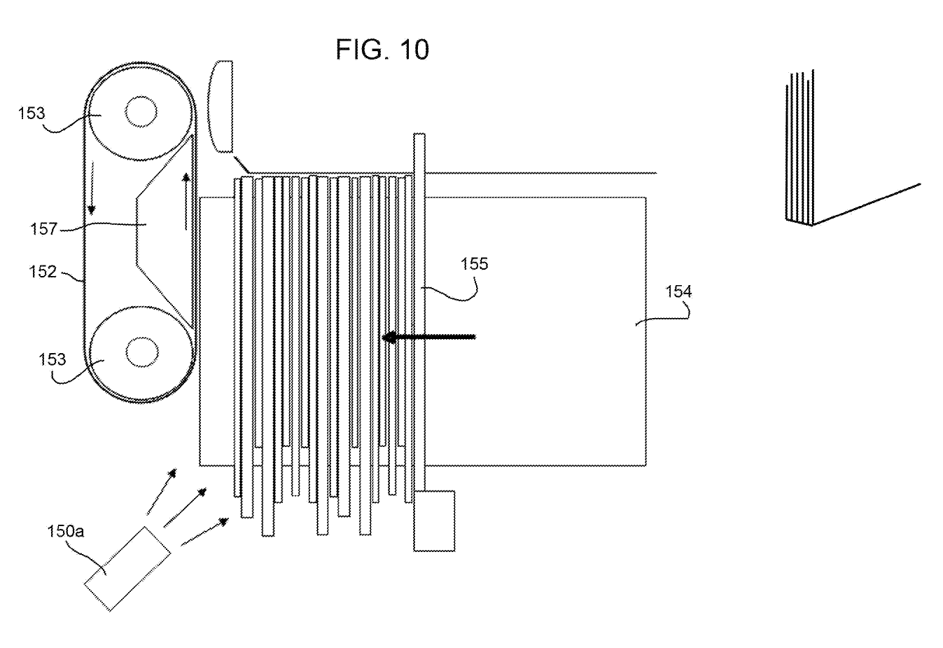

In particular, a video camera 150a can be used (FIG. 10) set in the proximity of a motor-driven singularization belt 152 of the singularizer device 15, which moves between a pair of pulleys 153 with vertical axis. The singularization belt 152 (provided with holes and coupled to a suction device 157) is designed to pick up postal objects one by one from a pack of postal objects (forming a lot) that moves on a resting surface 154 under the thrust of a motor-driven paddle 155. The video camera 150a is set on one side of the resting surface 154 and is oriented so as to detect an image of the end objects of the pack. The signal of the video camera 150a is then processed by means of known algorithms for detecting geometrical shapes indicating the presence of a spine with C-shaped cross section.

The detection of open magazines can occur, in the case where the postal objects are of the open-magazine type with V-shaped spine in which the pages of the magazine and the cover are held together by two metal staples, with the following modalities.

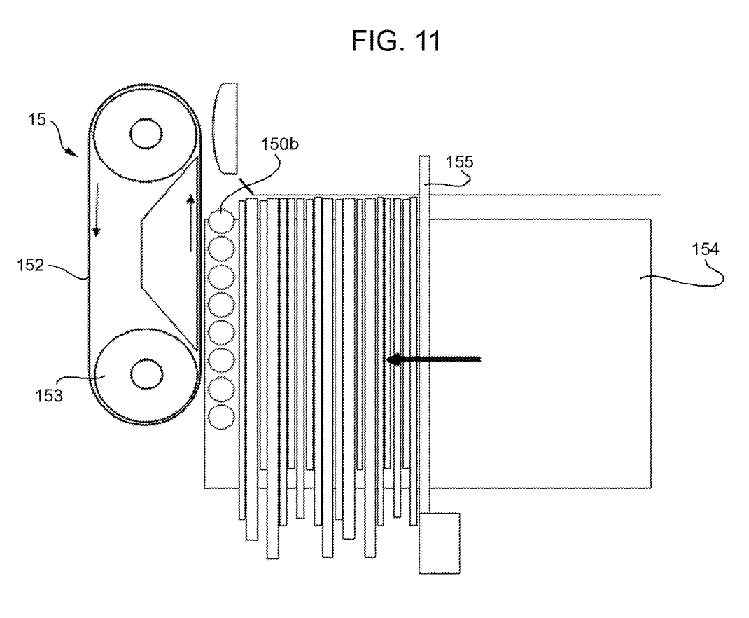

In particular, an array of sensors 150b can be used (FIG. 11, for example inductive sensors) set along a rectilinear path that extends in the proximity of a motor-driven singularization belt 152 of the singularizer device 15 that moves between a pair of pulleys 153 with vertical axis. The singularization belt 152 (provided with holes and coupled to a suction device 157) is designed to pick up postal objects one by one from a pack of postal objects (forming a lot) that moves on a resting surface 154 under the thrust of a motor-driven paddle 155. The sensors 150b are arranged underneath the resting surface 154 and are designed to detect the presence of the metal staples.

Alternatively, the detection of the metal staples can be carried out by a vision system that analyses the portion of image acquired via an image-acquisition system (of a known type, similar to the one represented in FIG. 10) and purposely provided algorithms of analysis capable of locating the presence of the staples (analysis of the difference of image between the spine part without staple and the spine part with staple) characterized by a particular reflectance and/or shape. In particular, the video camera is set underneath the resting surface 154 and is designed to examine the postal objects from beneath so as to analyse the image of the bottom closing spine of the postal objects, where the staples are present.

The sorting system 1 further comprises a mail-sorting device (FIG. 1), which receives a flow of postal objects 7b at input and has a plurality of outputs 21 onto which groups 13b of sorted postal objects 7b are fed.

The postal objects 7b are of the “flat” and/or “oversized” type and have dimensions markedly greater than the ones allowed for the standard postal objects (e.g. up to a length of 400 mm, a height of 305 mm, a thickness of 35 mm, and a weight of 3 kg).

As is known, each group 13b of sorted postal objects comprises a plurality of stacked postal objects, which belong to one and the same delivery path R even though they are not ordered according to successive delivery points (P2, P1, P7, . . . P0).

The creation of the group 13b of sorted postal objects 7b is obtained using techniques of a known type that not are further specified or described in detail; for this reason, the sorting device 20 is illustrated only schematically.

The mail-sorting device 20 is coupled to a singularizer device 25, which receives a plurality of lots L3 formed by the postal objects 7b and supplies at output the singularized postal objects 7b to the sorting device 20.

Each output 11 of the sorting device, if it is carrying out also sequencing 3, is logically coupled to and physically set close to (for example set underneath) an output 21 of the sorting device 20 in such a way that:
on each output 11 groups 13 of (standard or extended standard) postal objects 7 are present ordered according to successive delivery points (P0, P1, P2, . . . Pn) belonging to one and the same delivery path R;
present on a corresponding output 21 are groups 13b of flat and/or oversized postal objects 7b belonging to one and the same delivery path R but not necessarily ordered according to successive delivery points (P0, P1, P2, . . . Pn).

A postal operator P (schematically illustrated in FIG. 1) who finds himself physically in front of an output 11 and an output 21 can thus extract the group 13 of sequenced and sorted standard/extended postal objects and the group 13b of flat/oversized postal objects that have only been sorted and can then proceed to manual insertion (one by one) of the flat/oversized postal objects 7b in the group 13, thus manually sequencing also the flat/oversized objects 7b and at the same time providing merging of the flows of standard/extended mail with flows of flat/oversize mail.

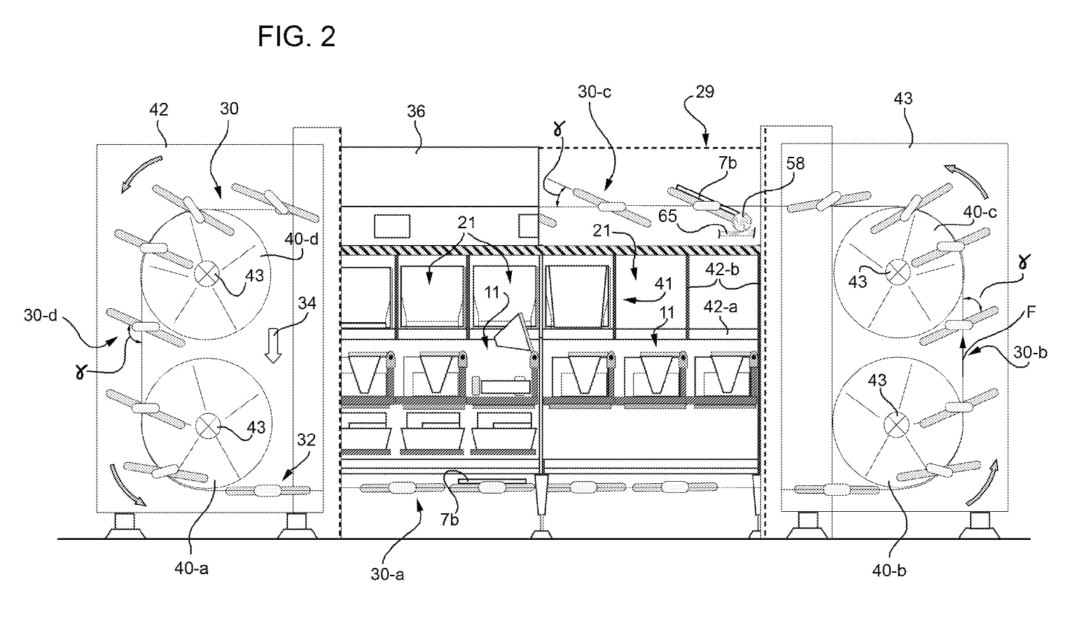

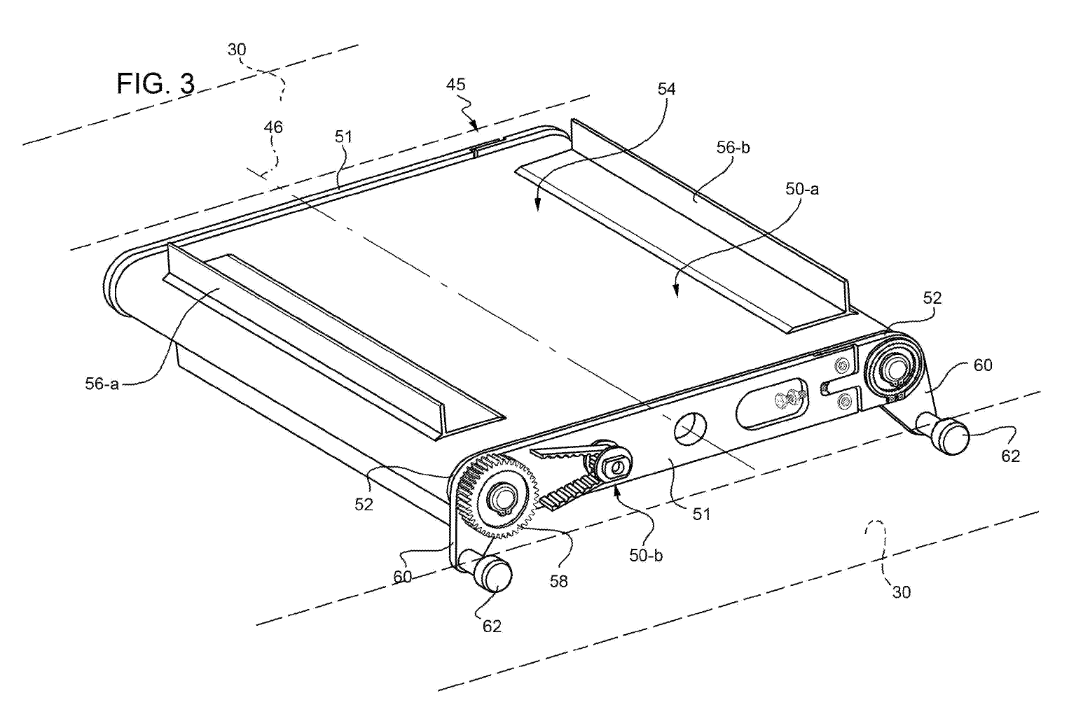

Preferably, the sorting device 20 comprises a final conveying system 29 of the type comprising (FIG. 2):
two belt elements 30 (the trace of the belt elements is indicated in FIG. 3) that move along two endless-loop paths under the thrust of motor means (for example, an electric motor, not illustrated), which lie in two parallel vertical planes;
a plurality of carriages 32 carried by the two belt elements 30 and linearly set at a distance from one another in the direction of one of the two belt elements 30 themselves (which, as has been said, lie in parallel vertical planes);
a loading station 34 (not illustrated) designed to feed, singly, postal objects 7b to the carriages 32 when the latter are set in a loading position;
a plurality of unloading stations 36 in which a postal object 7b contained in a respective carriage 32 set in an unloading position can be sent by gravity to a respective selected output 21.

In greater detail, the conveying system 29 may comprise four rollers 40 carried by a vertical supporting structure 42 (represented schematically), which are mobile about horizontal shafts 43 the traces of which are arranged, in a vertical plane, so that they correspond to the vertices of a rectangle. (Alternatively, the four rollers 40 can be replaced by two rollers having a larger diameter).

The belt elements 30 are carried by the rollers 40 in such a way as to follow:
a bottom horizontal stretch 30_{—}a, which extends between a pair of bottom rollers 40_{—}a, 40_{—}b set at a distance from one another;
an ascending vertical stretch 30_{—}b, which extends between the roller 40_{—}b and a roller 40_{—}c set in a top position;
a top horizontal stretch 30_{—}c, which extends between a pair of top rollers 40_{—}c, 40_{—}d set at a distance from one another; and
a descending vertical stretch 30_{—}d, which extends between the roller 40_{—}d and the roller 40_{—}a set in a bottom position.

In this way, the endless-loop path performed is of a rectangular shape with vertices replaced by arcs of a circumference.

The rollers 40, in the example illustrated, turn in a counterclockwise direction in such a way that also each belt element 30 moves in a counterclockwise direction.

The top horizontal stretch 30_{—}c extends above a central area of the supporting structure 42, in which the outputs 21 are provided. In particular, the outputs 21 are provided by respective parallelepipedal seats 41 set alongside one another and open upwards.

Each seat 41 is limited by a plane end wall 42_{—}a parallel to the horizontal and by two plane side walls 42_{—}b perpendicular to the end wall 42_{—}a. Free edges of the plane side walls 42_{—}b delimit an opening of the seat 41 facing upwards and set facing the top horizontal stretch 30_{—}c.

Underneath the plane end wall 42_{—}a of each output 21a respective output 11 is provided.

Each carriage 32 (FIG. 3) comprises a supporting structure 45, which is set between the two belt elements 30 parallel to one another and lying in the same plane; the supporting structure 45 can turn about a central horizontal axis 46 that passes through the trace of each belt element 30 (FIG. 2).

In greater detail, the supporting structure 45 of a plane type is delimited by a pair of approximately rectangular plane side walls 51, extending between which is a pair of idle rollers 52 set at the ends of the walls 51 and having axes parallel to one another, parallel to the axis 46 and perpendicular to the plane rectangular walls 51.

A belt 54 is set between the pair of rollers 52 and defines, with its opposite sides, a first plane resting surface 50_{—}a and a second plane resting surface 50_{—}b set on opposite faces of the supporting structure 45.

Each plane resting surface 50_{—}a, 50_{—}b is delimited in a transverse direction by a first rectangular arrest wall 56_{—}a and a second rectangular arrest wall 56_{—}b perpendicular to the belt 54 and extending in a direction parallel to the axis 46.

A roller 52 is angularly connected with a pinion 58, which extends laterally from the wall 51.

Finally, the end portions of a wall 51 are provided with triangular flanges 60, each of which is provided with a roller 62, the function of which will be clarified hereinafter.

The conveying system 29 is provided with a device designed to adjust the inclination γ of the first/second resting surface 50_{—}a/50_{—}b with respect to the instantaneous direction of advance of the belt element 30 (indicated by an arrow F).

In particular (FIG. 2):
in the bottom horizontal stretch 30_{—}a, the inclination γ is kept equal to zero (γ=0) in such a way that the resting surface 50_{—}a/50_{—}b sets itself parallel to the horizontal and coplanar with each belt element 30 so as to enable the operations of loading by the loading station 34 (not illustrated);
in the ascending vertical stretch 30_{—}b, the inclination γ is kept a little less than 90° (γ<90°) in such a way that the resting surface 50_{—}a/50_{—}b sets itself transverse with respect to the vertical and transverse to each belt element 30;
in the top horizontal stretch 30_{—}c, the inclination γ is kept a few degrees greater than zero (γ>0) in such a way that the resting surface 50_{—}a/50_{—}b sets itself slightly inclined with respect to the horizontal and with respect to each belt element 30;
in the descending vertical stretch 30_{—}d, the inclination γ is kept a little more than 90° (γ>90°) in such a way that the resting surface 50_{—}a/50_{—}b sets itself transverse with respect to the vertical and transverse to each belt element 30; and
in the areas of rotation performed by the rollers 40_{—}b and 40_{—}c a rotation is imparted upon the carriage 32 about the axis 46 that is concordant in direction to the rotation performed by the respective roller 40_{—}b, 40_{—}c.

The positioning of the carriage 32 with respect to the horizontal and the rotations illustrated above are obtained by means of guides (not illustrated), along which the rollers 62 run; said guides extend around the endless-loop path.

In use, the postal objects 7b coming from the sorting device 20 reach the loading station 34 where they are set individually on the carriages 32 with the resting surfaces 50_{—}a/50_{—}b parallel to the horizontal and coplanar with each belt element 30.

A substantially plane postal object 7b can hence rest on the resting surface 50_{—}a/50_{—}b setting itself between the arrest walls 56_{—}a, 56_{—}b.

The carriage 32 that carries a postal object 7b follows the bottom horizontal stretch 30_{—}a and then reaches the roller 40_{—}b, where the carriage 32 is made to rotate in a direction concordant with the direction of rotation (counterclockwise in the example) of the roller 40_{—}b in order to reduce the tangential component of the centrifugal acceleration that acts on the postal object 7b and prevent the latter from falling out of the carriage 32.

Next, the postal object 7b sets itself transverse with respect to the vertical along the ascending vertical stretch 30_{—}b and reaches the top roller 40_{—}c, where the carriage 32 is again made to turn in a direction concordant with the direction of rotation (counterclockwise in the example) of the roller 40_{—}c in order to reduce the tangential component of the centrifugal acceleration that acts on the postal object 7b and prevent the latter from falling out of the carriage 32.

Next, the carriage 32 (and the postal object 7b) follows the top horizontal stretch 30_{—}c that is set above the outputs 21.

When the carriage 32 is set above the output 21 to which the postal object 7b is to be sent, coupling is performed with a pinion 58 and a rack 65 (FIG. 2) that is lowered from a resting position to a position of activation where it meshes with the pinion 58 carried by the carriage 32 in order to unload the postal object 7b towards the selected output 11.

Coupling between the rack 65 carried by the supporting structure 42 (and hence having a fixed position) and the pinion 58 (mobile with the carriage 32 under the thrust of the belt 30) in fact brings about rotation of the rollers 52, which in turn produce advance of the belt 54, which unloads the postal object from the carriage 32 to the output 21.

Alternatively, movement of the belt 54 in a position corresponding to a specific output 21 can be performed by activating an electric motor (not illustrated) carried on board the carriage 32. The electrical power can be supplied to the motor by means of mobile sliding contacts (not illustrated) or by electromagnetic induction, and the control of unloading can be provided, for example, through sensors of an optical type (emitter set on the ground; receiver set on board the carriage).

The postal object 7b falls into the parallelepipedal seat 41 selected (which is open upwards in order to enable entry of the postal object 7b) and sets itself on the plane end wall 42_{—}a (in the case where the output 21 is empty) or on a postal object 7b already contained in the parallelepipedal seat 41.

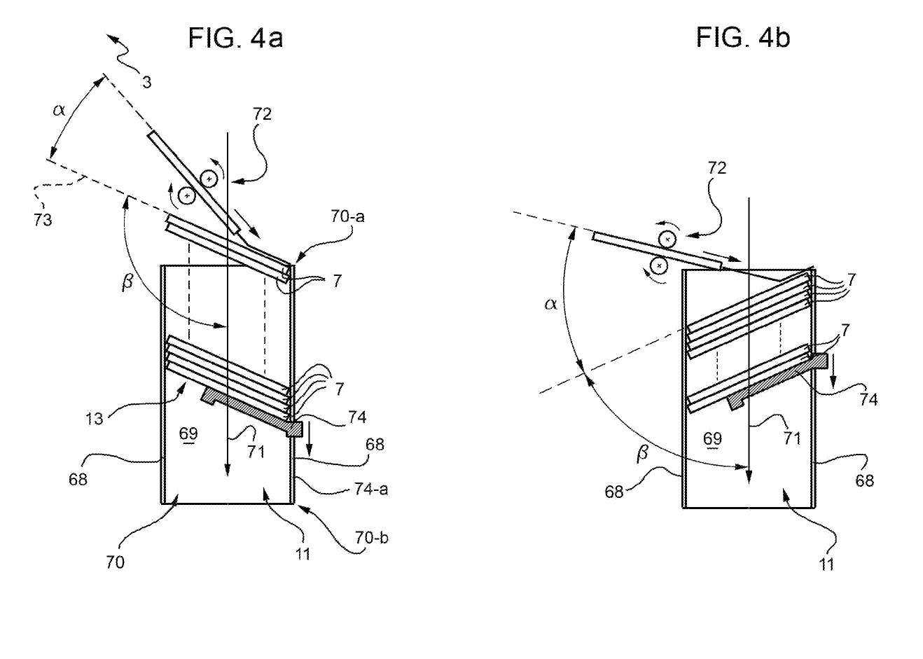

FIG. 4 illustrates, in top plan view, an output 11 which comprises a rectilinear channel 70 with rectangular cross section (set beneath the seat 41), which defines a rectilinear direction 71 of advance of the postal objects 7 that have accumulated in the channel 70 itself.

In particular, the rectilinear channel 70 comprises a first end portion 70_{—}a to which the postal objects 7 coming from the sorting and sequencing device 3 are fed and a second end portion 70_{—}b from which the groups 13 of postal objects 7 stacked on top of one another in a pack are picked up.

The channel 70 is delimited by a plane rectangular end wall 69, by two plane rectangular side walls 68, and by a paddle 74, which is mobile in the same rectilinear direction 71 as the channel 70.

The postal objects 7 packed on top of one another are inclined with respect to the direction of advance 71 according to an angle β different from 90° (typical standard of stacker sorters). The angle β can be, as illustrated in FIGS. 4 and 4b, greater or smaller than 90° by a value, which can be determined by simple trigonometric relations, such as to enable physical housing of postal objects 7 of a length greater than the width of the channel 70.

The paddle 74 (having a structure of a known type and consequently not described in further detail) is defined by a plane body, which lies in a plane that forms an angle β with respect to the rectilinear direction 71. The paddle 74 has an end portion that slides along a rectilinear guide 74_{—}a parallel to the direction 71.

Means 72 are provided (for example, constituted by a pair of counter-rotating rollers) for single supply of the postal objects 7 to the first end portion 70_{—}a of the rectilinear channel 70, said means being configured in such a way that each (plane rectangular) postal object 7 will be fed to the rectilinear channel 70 along a vertical plane of advance, the trace of which (designated by the reference number 73) forms an angle α of approximately 20-30° with respect to the plane in which the packed plane postal objects 7 lie.

Following upon complete entry of the postal object 7 into the channel 70, said postal object is displaced in the rectilinear direction towards the second end portion 70 a to enable entry of a new postal object 7. The displacement of the postal objects occurs with techniques of a known type (not illustrated). The repetition of the operations illustrated above provides a pack of postal objects 7 having planes of lie parallel to one another and inclined by an angle β different from 90° with respect to the rectilinear direction 71 and to the side walls 68 of the rectilinear channel.

In this way, on account of the stacking illustrated above, the occupation of space inside the channel 70 is improved.

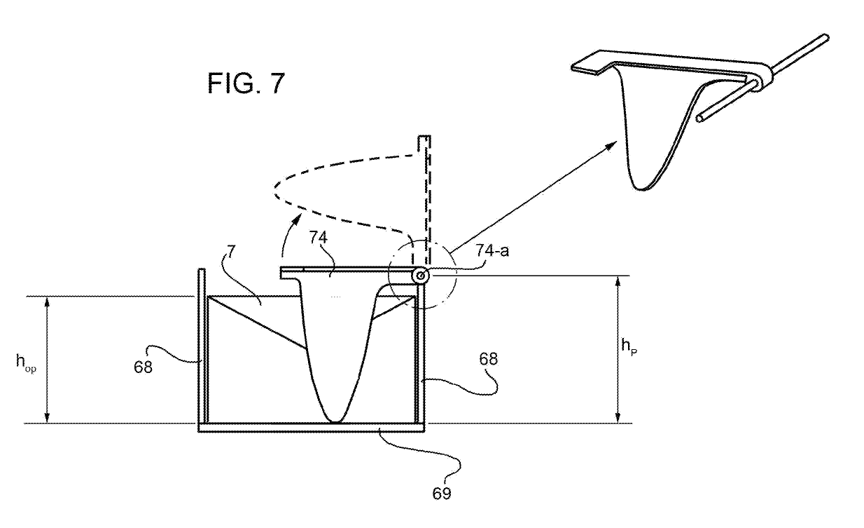

In addition, once again in order to improve the occupation of space inside the channel 70, there is also adopted a solution (FIG. 7) for hinging the paddle for containing the pack of postal objects; namely, the distance hₚ of the axis of hinging about the guide 74_{—}a with respect to the base of the rectilinear channel 69 is greater than the maximum height hₒₚ of the postal objects processed by the machine. In this way, in the lowest part of the channel 70 (at least as far as the maximum height of the postal objects 7), the lateral containment sides 68 can present a minimum wall thickness (of a few millimetres), enabling optimization of the overall occupation of space of a contiguous set of stackers.

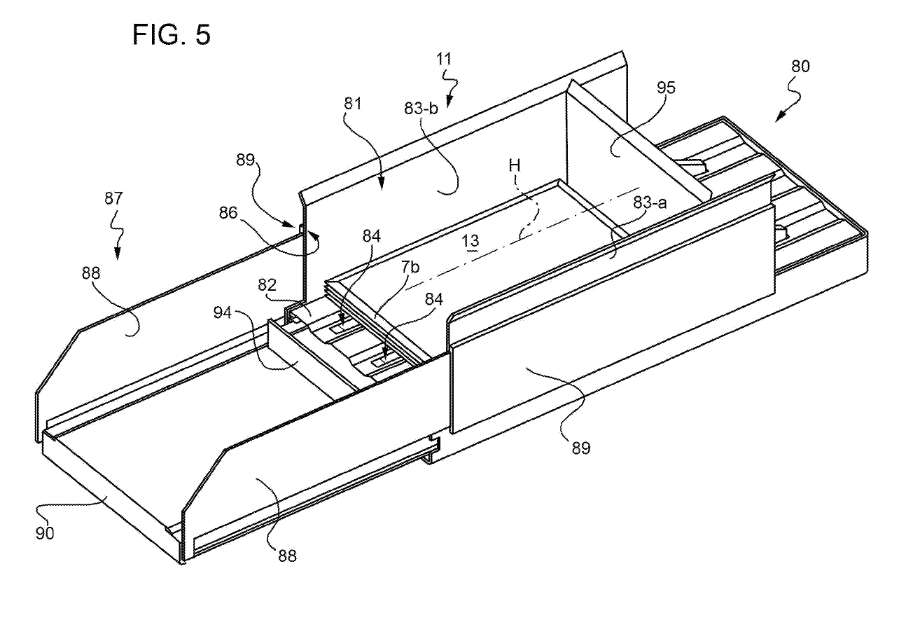

FIG. 5 illustrates in detail an output 21 in which the groups 13 of flat and/or oversized postal objects 7b are accumulated, which, as has been highlighted above, have dimensions considerably greater than those allowed for standard postal objects. For this reason, a group 13 of postal objects 7b can reach a non-negligible weight (some kilograms), thus rendering difficult unloading of the group 13 from the output 21. There has consequently been provided a device 80 designed to facilitate unloading of the group 13 from the output 21.

The output 21, in the embodiment illustrated in FIG. 5 comprises a rectilinear channel 81 with rectangular cross section defining a rectilinear direction H of advance. The rectilinear channel 81 is delimited by a plane rectangular horizontal bottom wall 82 and by two plane rectangular lateral sides 83_{—}a, 83_{—}b perpendicular to the rectangular bottom wall and extending along major-side edges of the rectangular bottom wall 82.

Minor perimetral edges of the bottom wall 82 and of the side walls 83_{—}a, 83_{—}b define an output 86 of the channel 81 for unloading of a group 13.

The bottom wall 82 has a plurality of rectilinear grooves 84 parallel to one another and extending substantially throughout the length of the bottom wall in a direction parallel to the direction of advance H.

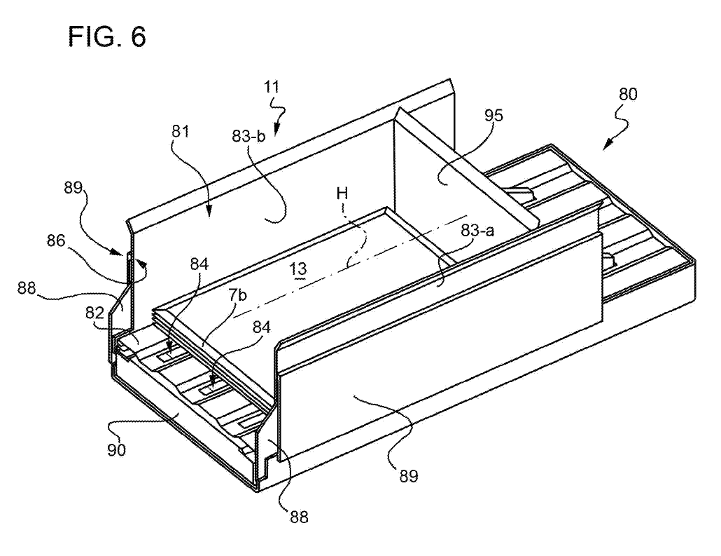

The rectilinear channel is coupled to a cradle 87, which is mobile between a retracted position (illustrated in FIG. 6), in which it is integrated with the structure defining the rectilinear channel 81, and an extracted position (represented in FIG. 5), in which it provides a prolongation of the channel 21 setting itself in communication with the output 86 for receiving from the channel 21 the pack of postal objects 13.

In greater detail, the cradle 87 comprises two plane rectangular side walls 88, which are parallel to and set facing one another and are able to slide with a reciprocating motion in the direction H along respective guides 89 carried by the side walls 83_{—}a, 83_{—}b. The side walls 88 are arranged in vertical planes parallel to the planes in which the side walls 83_{—}a, 83_{—}b lie.

The cradle 87 comprises also a plane rectangular bottom wall 90, which extends between bottom edges of major side of the side walls 88 in a horizontal plane lower than that in which the bottom wall 82 lies.

In particular, in the retracted position, the side walls 88 are completely inserted in the guides 89, and the bottom wall is set underneath the bottom wall 82, whilst in the extracted position the side walls 88 are completely extracted from the guides 89 (from which they extend in cantilever fashion), and the bottom wall 90 constitutes a prolongation of the bottom wall 82.

Motion of the cradle 87 from the retracted position to the extracted one is performed by a thrust device, which comprises an actuator (not illustrated), which is set underneath the structure that provides the channel 81 and is equipped with an output member (not illustrated) that bears upon a contrast wall 94 perpendicular to the bottom wall 90 of the cradle 87 and extending along a minor end edge of the bottom wall 90.

The motion of the cradle 87 from the extracted position to the retracted position is, instead, performed manually by pushing the cradle 87 in the opposite direction.

The channel 81 carries also a thrust member 95, which is provided by a rectangular wall perpendicular to the bottom wall 82 and is provided with bottom portions that are able to slide along the rectilinear grooves 84 under the thrust of the actuator (not illustrated), which provides also the motion of extraction of the cradle 87.

In use, during the operations of formation of the group 13 of postal objects 7b, the cradle is set in the retracted position. In particular, a first postal object 7b is rested on the bottom wall 82, and successive postal objects are fed to the channel 81 and rest upon the objects already present in the channel 81 to form a group of stacked plane postal objects. Conveniently, feed of the postal objects 7b occurs from the top by means of feed devices described above (the belt 54 and the carriages 32).

When the height of the group of postal objects 7b contained inside the channel 81 reaches a limit height or else when the lot being processed has been completed, the unloading (dropping from above) of postal objects 7b into the channel 81 is stopped. The operations of unloading of the group 13 of packed postal objects 7b can hence be activated.

For this purpose, the actuator (not illustrated) is activated, which produces motion of the thrust member 95, which in turn produces motion of the group 13 of packed postal objects 7b towards the output 86 and simultaneously produces motion of the cradle 87 towards the extracted position. In this way, the group 13 of packed postal objects 7b slides initially on the bottom wall 82 and then on the bottom wall 90.

Upon completion of said operations, the group 13b of packed postal objects 7b arranges itself on the cradle 87 set in the extracted position. In said position, the group 13b of packed postal objects 7b can easily be picked up by an operator.

At the end of this step, the thrust member 95, moved by the actuator (not illustrated), is brought back into the retracted position so as to enable the sorter to resume the operations of unloading of postal objects 7b belonging to a subsequent lot to be processed, into the outputs 21 on the bottom walls 82.

Typically, extraction from the retracted position to the extracted position, with consequent transfer of the stack of postal objects 7b onto the cradle 90 can also take place simultaneously for multiple outputs 21 (the cradles are extracted all together or in subsets when the lot being processed is completed).

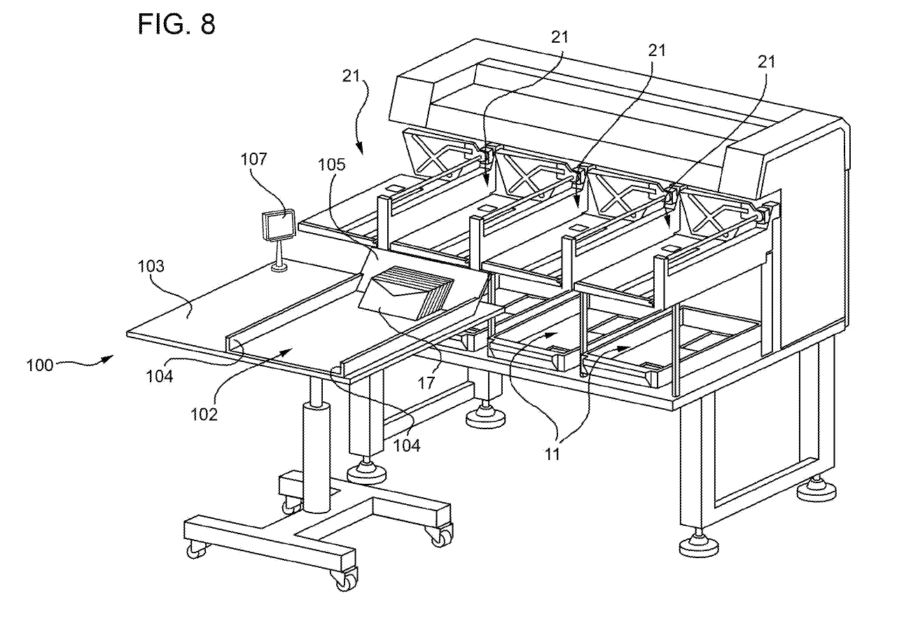

FIG. 8 represents a table 100 (of which by way of example an embodiment is provided) for supporting the operations of manual merging, performed by the postal operator, of the flow of flat/oversized mail within the pack of sequenced standard/extended mail.

The table 100 is equipped with a system of guides and wheels of a known type (illustrated schematically) that enables a convenient translation thereof along the front of the machine so as to enable its displacement by the operator in front of the pair of superimposed outputs 11-21 in the emptying step.

Said table 100 is moreover equipped with a rectilinear channel with rectangular cross section 102 delimited by a resting wall 103 of the surface of the table 100 and by two rectangular side walls 104 perpendicular to the resting wall 103 and parallel to one another. Moreover provided is a resting base 105 that can be mounted inside the rectilinear channel 102 by setting it inclined with respect to the resting surface 103.

In use, during the unloading operations, the operator positions, with the aid of guide mechanisms of a known type (not illustrated), the table 100 in such a way that the rectilinear channel 102 thereof is aligned to the output 11 being emptied, precisely in such a way that the rectilinear channel 102 is aligned with the channel 70 of the output 11.

In this way, after raising and displacement of the mobile paddle 74 it is possible to transfer the pack 13 of sequenced postal objects 7 by simple translation from the channel 70 to the channel 102 present on the table 100.

Starting from one of the outputs 11 to be emptied, the operator will proceed to emptying one after the other all the outputs belonging to a group being emptied, availing himself of the supporting table 100, which is made to translate at each step.

For example, the operator can pick up in bunches or all together the pack of flat/oversized postal objects 7b from the extracted cradle 90 and deposit it on a side of the table 100. Next, he will transfer, as described above, the pack 11 of sequenced postal objects 7 inside the rectilinear channel 102, at the end of this step said postal objects being stacked in an inclined way so as to facilitate the subsequent merging operations.

The operator will pick up one flat/oversized postal object at a time from the pack positioned on the table 100 and, also on the basis of auxiliary information displayed on a display 107 present on the table 100 extracted by the sorting-control system, will insert it in the right position of the pack of sequenced postal objects 7 according to the sequence (P0, P1, P2, . . . Pn) corresponding to the delivery path R; for example, it will be possible to display the position in the stack (even approximately, e.g., ¼ of the stack) in which the flat is to be inserted inside the pack of sequenced objects 7.

As an alternative to displaying on the screen 107, said auxiliary information provided as an aid to the merging operations may be printed on a label.

In use, during other processing steps in which, unlike the modalities just described, the use is envisaged of containers for collecting the sorted correspondence, positioned inside the outputs 21 and lying precisely on the bottom walls 82 are containers designed to receive the flat and/or oversized correspondence unloaded from the sorting machine; when the container is physically full (condition detected through sensors of a known type and not illustrated) or else the lot being processed is completed, the container is extracted from the output according to the same modalities described previously for the pack of postal objects 7b.

More precisely the actuator (not illustrated) is activated, which produces the motion of the thrust member 95, which in turn produces the motion of the container, inside which the postal objects 7b are deposited, towards the output 86, and simultaneously produces the motion of the cradle 87 towards the extracted position. In this way, the container slides initially on the bottom wall 82 and then on the bottom wall 90.

At the end of said operations, the container sets itself on the cradle 87 in the extracted position. In this position, the container is easily picked up by an operator.

1. A singularizer device for a mail-sorting system configured to receive at input homogeneous lots of postal objects and feeding at output postal objects that are singularized, i.e., physically separated from one another, to said mail-sorting system, each lot of homogeneous postal objects comprising postal objects having common dimensional parameters and/or physical/constructional parameters,
said singularizer device comprising sensor means to detect a type of lot fed at input for executing automatically a respective singularization program suited to the type of postal objects detected.

2. The device according to claim 1, wherein said singularizer device is configured for distinguishing between a first type of lots (L1) of postal objects having at least one dimensional parameter of less than a threshold (S1) and a second type of lots (L2) having said dimensional parameter of more than the threshold (S1).

3. The device according to claim 2, wherein the lots (L1) and (L2) are constituted by a single postal object.

4. The system according to claim 2, wherein said singularizer device is configured to implement automatically respective first and second singularization parameters for singularization of said first/second (L1/L2) lots on the basis of the indication supplied by said sensors.

5. The system according to claim 4, wherein the first singularization program implements the following parameters of the singularizer device:
conveying rate: 3.8 m/s;
singularization gap: 20 ms; and
acceleration ramp: 15 ms.

6. The system according to claim 4, wherein the second singularization program implements the following parameters of the singularizer device:
conveying rate: 3.0 m/s;
singularization gap: 40 ms; and
acceleration ramp: 40 ms.

7. The system according to claim 4, wherein the first singularization program implements the following parameters of the singularizer device:
conveying rate: 3.8 m/s;
singularization gap: 20 ms; and
acceleration ramp: 15 ms.
and the following settings:
rate advance of magazine belt: 10 cm/s;
level of vacuum in the suction chamber of the extraction belt: 200 mbar;
distance of the anti-double assembly from the extraction belt: 0.2 mm; and
braking force of the anti-double assembly orthogonal to the letter being extracted equal to a first value.

8. The system according to claim 4, wherein the second singularization program implements the following parameters of the singularizer device:
conveying rate: 3.0 m/s;
singularization gap: 40 ms; and
acceleration ramp: 40 ms.
and the following settings:
rate of advance of the magazine belt: 5 cm/s;
level of vacuum in the suction chamber of the extraction belt: 100 mbar;
distance of the anti-double assembly from the extraction belt: 3 mm; and
braking force of the anti-double assembly orthogonal to the letter being extracted equal to 3N.

9. The system according to claim 1, wherein said singularizer device is configured to recognize a type of lots of postal objects defined by the presence of a plasticated wrapper that encloses the postal object itself.

10. The device according to claim 9, wherein a video camera is used set in the proximity of a motor-driven singularization belt of the singularizer device designed to take one postal object at a time from a pack of postal objects forming a lot; the video camera is designed to examine end objects of the pack, supplying a signal that is processed to detect areas of the image indicating the presence of a plasticated wrapper.

11. The system according to claim 1, wherein said singularizer device is configured to recognize a type of lots of postal objects formed by open magazines, each of which is formed by a plurality of folded sheets grouped together.

12. The device according to claim 11, wherein a video camera is used set in the proximity of a motor-driven singularization belt of the singularizer device designed to take one postal object at a time from a pack of postal objects forming a lot; the video camera is oriented so as to detect an image of the end objects of the pack; the signal of the video camera is processed for detecting geometrical shapes indicating the presence of a spine with C-shaped cross section of the magazine.

13. The device according to claim 11, wherein means are provided to detect open magazines, each of which is formed by a plurality of folded sheets grouped together by means of metal staples.

14. The device according to claim 13, wherein said detection means are designed to detect the presence of metal staples and comprise an array of sensors set along a path that extends in the proximity of a motor-driven singularization belt of the singularizer device, the belt being designed to take one postal object at a time from a pack of postal objects forming a lot.

15. The device according to claim 13, wherein said detection means are designed to detect the presence of metal staples and comprise image-acquisition means capable of locating on the image detected the presence of the staples, by means of image-processing algorithms.
